(19) United States
(12) Patent Application Publication
(10) Pub. No.: US 2012/0113238 A1
(43) Pub. Date: May 10, 2012

(54) DRAWN IMAGE SHARING APPARATUS, DRAWN IMAGE SHARING SYSTEM, AND DRAWN IMAGE SHARING METHOD

(75) Inventors: Kengo YAMAMOTO, Kanagawa (JP); Yuuji Kasuya, Kanagawa (JP); Keiji Ohmura, Kanagawa (JP)

(73) Assignee: RICOH COMPANY, LTD., Tokyo (JP)

(21) Appl. No.: 13/281,594

(22) Filed: Oct. 26, 2011

(30) Foreign Application Priority Data
Nov. 5, 2010 (JP) 2010-248729

(51) Int. Cl. H04N 7/18

(52) U.S. Cl. 348/61; 348/E07.085

(57) ABSTRACT

A disclosed drawn image sharing apparatus making objects to be drawn on share drawn images includes an image receiving portion from another drawn image sharing apparatus; an image supplying portion supplying a received image to a focusing device to produce an image; an image acquiring portion acquiring a sharing image from an image capturing device; an image difference generating portion generating a difference image between the produced image and the captured image in a sharing region; and an image dividing portion dividing the acquired image into first and second images, wherein in an adjusting mode, the image difference generating portion generates first and second difference images between the supplied images corresponding to the same regions and the first and second images, and the image combining portion substitutes the positions of the first and the second difference images and combines the first and the second difference images.

### BACKGROUND OF THE INVENTION

1. Field of the Invention

The present invention generally relates to a drawn image sharing apparatus, a drawn image sharing system, and a drawn image sharing method.

2. Description of the Related Art

In recent years, an image drawn on an object to be drawn on such as a whiteboard or a blackboard located at a locational point may be shot by an image capturing device such as a camera. The image drawn on the object to be drawn on may be projected on another object to be drawn on located at another locational point in order to be used in a remote meeting and so on. In this case, images drawn on plural objects to be drawn on may be shared by the plural objects to be drawn on. Said differently, synthetic images obtained by synthesizing images drawn on plural objects to be drawn on having the same contents may be displayed on the objects to be drawn on using focusing devices such as projecting devices and image capturing devices.

For example, projectors for projecting images and servers for sending the images may be provided in remote places, respectively. The projector may include an image capturing unit for capturing an image written in a screen on which a projected image is projected and a sending unit for sending the written image captured by the image capturing unit. The server may include a synthesizing unit for synthesizing the written image received by another projector with the originally projected image and a transferring unit for sending the synthesized image to the other projector to thereby support remote meetings as disclosed in Patent Document 1.

In this case, it is necessary to temporarily stop projecting the images with predetermined time intervals to capture the written images. Therefore, visibility of the images displayed on the screen (the object to be drawn on) may be degraded.

To solve the degradation, an image sent from a drawn image sharing apparatus may be received by another drawn image sharing apparatus, the received image may be supplied to a projecting device so as to be projected on an object to be drawn on, a captured image may be acquired by a sharing region for sharing images among a plurality of objects to be drawn on from an image capturing device, a difference image representing a difference between the projected image and the captured image in the sharing region may be generated, and the difference image may be sent to the other drawn image sharing apparatus as disclosed in Patent Document 2.
Patent Document 1: Japanese Laid-Open Patent Application No. 2005-203886
Patent Document 2: Japanese Laid-Open Patent Application No. 2011-151764

### SUMMARY OF THE INVENTION

Accordingly, embodiments of the present invention provide a novel and useful drawn image sharing apparatus, a drawn image sharing system, and a drawn image sharing method solving one or more of the problems discussed above.

One aspect of the embodiments of the present invention may be to provide a drawn image sharing apparatus making a plurality of objects to be drawn on share images drawn on the objects to be drawn on with focusing devices and image capturing devices, the drawn image sharing apparatus including: an image receiving portion configured to receive images sent from another drawn image sharing apparatus; an image supplying portion configured to supply the received image to the focusing device to produce an image on the object to be drawn on; an image acquiring portion configured to acquire a sharing region image of a sharing region, on which the images are shared, from the image capturing device which captures the sharing image; an image difference generating portion configured to generate a difference image being a difference between an image produced by the focusing device and the image captured by the image capturing device in the sharing region; an image sending portion configured to send the difference image to the other drawn image sharing apparatus; an image dividing portion configured to divide the image acquired by the image acquiring portion into a first image and a second image; and an image combining portion configured to combine the difference image generated by the image difference generating portion, wherein in an adjusting mode of adjusting the image capturing device, the image difference generating portion generates a first difference image being a difference between one of the images supplied by the image supplying portion corresponding to the same region as a region of the first image and the first image and a second difference image being a difference between one of the images supplied by the image supplying portion corresponding to the same region as a region of the second image and the second image, the image combining portion arranges the first difference image at a position of the second image and arranges the second difference image at a position of the first image and thereafter combines the first difference image and the second difference image, and the image supplying portion supplies the combined image to the focusing device to produce the image.

Additional objects and advantages of the embodiments will be set forth in part in the description which follows, and in part will be clear from the description, or may be learned by practice of the invention. Objects and advantages of the invention will be realized and attained by means of the elements and combinations particularly pointed out in the appended claims.

It is to be understood that both the foregoing general description and the following detailed description are exemplary and explanatory only and are not restrictive of the invention as claimed.

### BRIEF DESCRIPTION OF THE DRAWINGS

FIG. 1 schematically illustrates a drawn image sharing system of embodiments.

FIG. 2 is a block chart of hardware of an drawn image sharing apparatus of the embodiments.

FIG. 3 is a block chart illustrating functions of the drawn image sharing apparatus of the embodiments.

FIG. 4 schematically illustrates a sharing region determined by the drawn image sharing apparatus of the embodiments.

FIG. 5 schematically illustrates an image example divided by the image dividing portion included in the drawn image sharing apparatus of the embodiments.

FIG. 6A schematically illustrates an exemplary image combined by an image coupling portion included in the drawn image sharing apparatus of the embodiments where a first difference image is simply combined with a second difference image.

FIG. 6B schematically illustrates an exemplary image combined by an image coupling portion included in the drawn image sharing apparatus of the embodiments where an image indicative of a boundary of the first difference image and an image indicative of a boundary of the second difference image are superposed on the first difference image and the second difference image.

FIG. 7 is a flowchart of a shared image receiving operation in a normal mode of the drawn image sharing apparatus of the embodiments.

FIG. 8 is a flowchart of a captured image receiving operation in the normal mode of the drawn image sharing apparatus of the embodiments.

FIG. 9 schematically illustrates an exemplary operation in a normal mode of a drawn image sharing system of the embodiments.

FIG. 10 is a flowchart illustrating an exemplary difference image generating process in the captured image receiving operation illustrated in FIG. 8.

FIG. 11 is a flowchart illustrating an exemplary average difference calculating process carried out in the difference image generating process illustrated in FIG. 10.

FIG. 12 is a flowchart illustrating an exemplary difference calculating process carried out in the difference image generating process illustrated in FIG. 10.

FIG. 13 is a flowchart of a captured image receiving operation in an adjusting mode of the drawn image sharing apparatus of the embodiments.

FIG. 14 schematically illustrates an exemplary operation in the adjusting mode of the drawn image sharing system of the embodiments.

FIG. 15 schematically illustrates the drawn image sharing system of another mode of the embodiments.

### DETAILED DESCRIPTION OF THE PREFERRED EMBODIMENTS

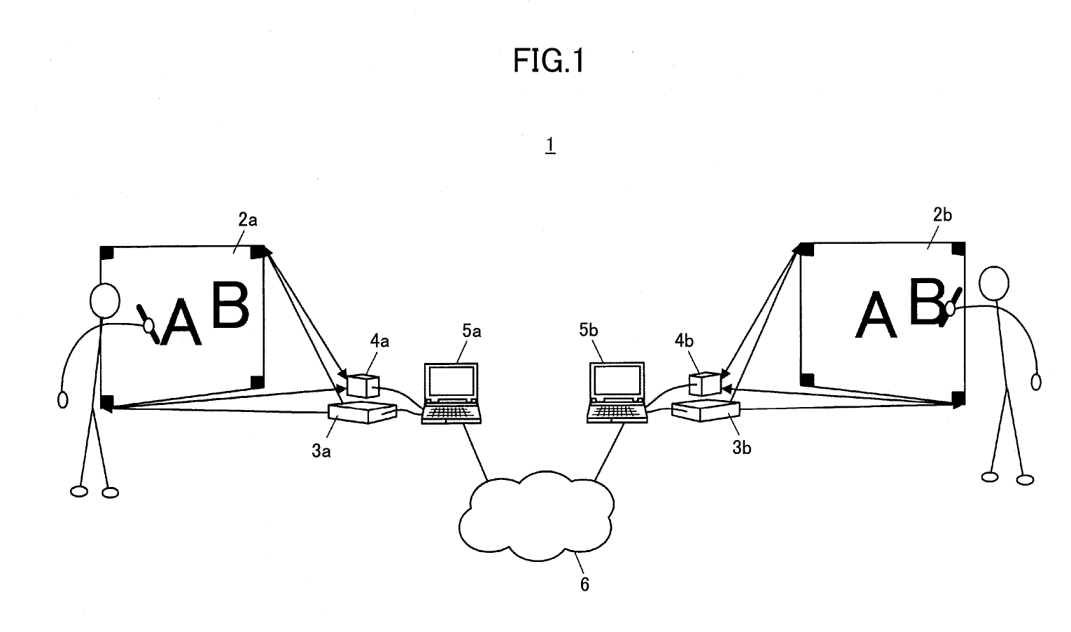

A description is given below, with reference to the FIG. 1 through FIG. 15 of embodiments of the present invention.

Reference symbols typically designate as follows:
1: drawn image sharing system;
2,2a,2b: whiteboard;
3,3a,3b: projecting device;
4,4a,4b: image capturing device;
5,5a,5b: drawn image sharing apparatus;
6: network;
10: CPU;
11: RAM;
12: ROM;
13: hard disk device;
14: input device;
15: display device;
16: device communicating module;
17: network communicating module;
20: image receiving portion;
21: image supplying portion;
22: image acquiring portion;
23: image difference generating portion;
24: image sending portion;
25: image removing portion;
26: image dividing portion; and
27: image coupling portion.

As described above, the image drawn on the object to be drawn on may be sent to the other drawn image sharing apparatus without stopping displaying the image on the object to be drawn on. Therefore, images drawn on plural objects to be drawn on may be shared by the plural objects to be drawn on.

However, with the above technique, a difference image sent to the other drawn image sharing apparatus is not checked by an own apparatus sending the difference image. Therefore, if the difference image sent to the destination (the other drawn image sharing apparatus) is not clear, it is necessary to set up an image capturing device while receiving an instruction from the destination, but the image capturing device is not optimally set up with ease.

Preferred embodiments of the present invention are explained next with reference to accompanying drawings.

As illustrated in FIG. 1, the drawn image sharing system 1 of First Embodiment includes whiteboards 2a, 2b (hereinafter, collectively referred to as a whiteboard 2) as an object to be drawn on respectively provided in locational points such as plural meeting rooms, projecting devices 3a, 3b (hereinafter, collectively referred to as a projecting device 3) corresponding to the whiteboards 2a, 2b, image capturing devices 4a, 4b (hereinafter, collectively referred to as an image capturing device 4), and drawn image sharing apparatuses 5a, 5b (hereinafter, collectively referred to as a drawn image sharing apparatus 5).

With the First Embodiment, an example in which a whiteboard is used as the object to be drawn on is described. With embodiments of the present invention, a blackboard, a paper or the like may be used as the object to be drawn on.

For example, the projecting device 3 is constituted by an ordinary projector and projects an image sent from the drawn image sharing apparatus 5. The projecting device 3 is installed so as to project an image within a drawing area of the whiteboard 2.

With the First Embodiment, the focusing device constitutes the projecting device 3. However, a display device such as a liquid crystal display device may be used as the focusing device of the present invention. When the display device is provided as the focusing device of the present invention, a board on which an image such as a dot and a line can be drawn and which has optical transparency is provided on a display surface of the display device.

Referring to FIG. 1, the drawing area of the whiteboard 2 is the same as the projecting range of the projecting device 3. However, a part of the drawing area of the whiteboard 2 may be the projecting range of the projecting device 3.

For example, the image capturing device 4 may be constituted by an ordinary video camera and may send an image displayed on the whiteboard 2 captured with a predetermined time interval such as once every 0.5 seconds or fifteen times every 1 second. The image capturing device 4 is located so as to capture the projecting range of the projecting device 3.

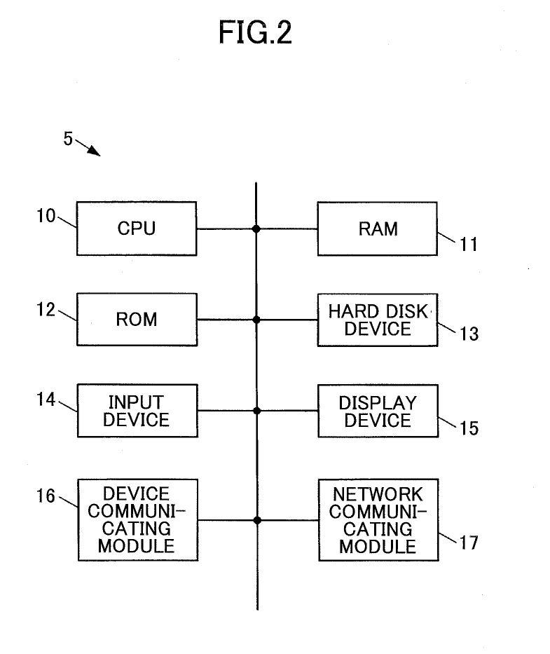

Referring to FIG. 2, the drawn image sharing apparatus 5 may be constituted by an ordinary computer including a Central Processing Unit (CPU) 10, a Random Access Memory (RAM) 11, a Read Only Memory (ROM) 12, a hard disk device 13, an input device 14 including a keyboard, a pointing device and so on, a display device 15 including a liquid crystal display and so on, a device communicating module 16 for communicating with peripheral devices such as the projecting device 3 and an image capturing device 4, and a network communicating module 17 for communicating with external apparatuses such as other drawn image sharing apparatuses 5 connected via a network 6.

With the First Embodiment, it is described that the drawn image sharing apparatuses 5 are connected via the network 6 such as the Internet (referring to FIG. 1). However, the drawn image sharing apparatuses 5 may be connected via a leased line and so on. As described, the display device 15 may constitute the focusing device of the First Embodiment.

The ROM 12 and the hard disk device 13 store programs for causing the computer to function as the drawn image sharing apparatus 5. Said differently, when the CPU 10 executes the program stored in the ROM 12 and hard disk device 13 using the RAM 11 as a working area, the computer functions as the drawn image sharing apparatus 5.

The drawn image sharing apparatus 5 adopts one of a normal mode in which an image drawn on the whiteboard 2 is shared by the drawn image sharing apparatus 5 and the other drawn image sharing apparatus 5 and an adjusting mode in which the image capturing device 4 is adjusted. Ordinarily, the drawn image sharing apparatus 5 shares the image drawn on the whiteboard 2 with the other drawn image sharing apparatus 5 in the normal mode after the image capturing device 4 is adjusted in the adjusting mode. These modes are switched over by the input device 14.

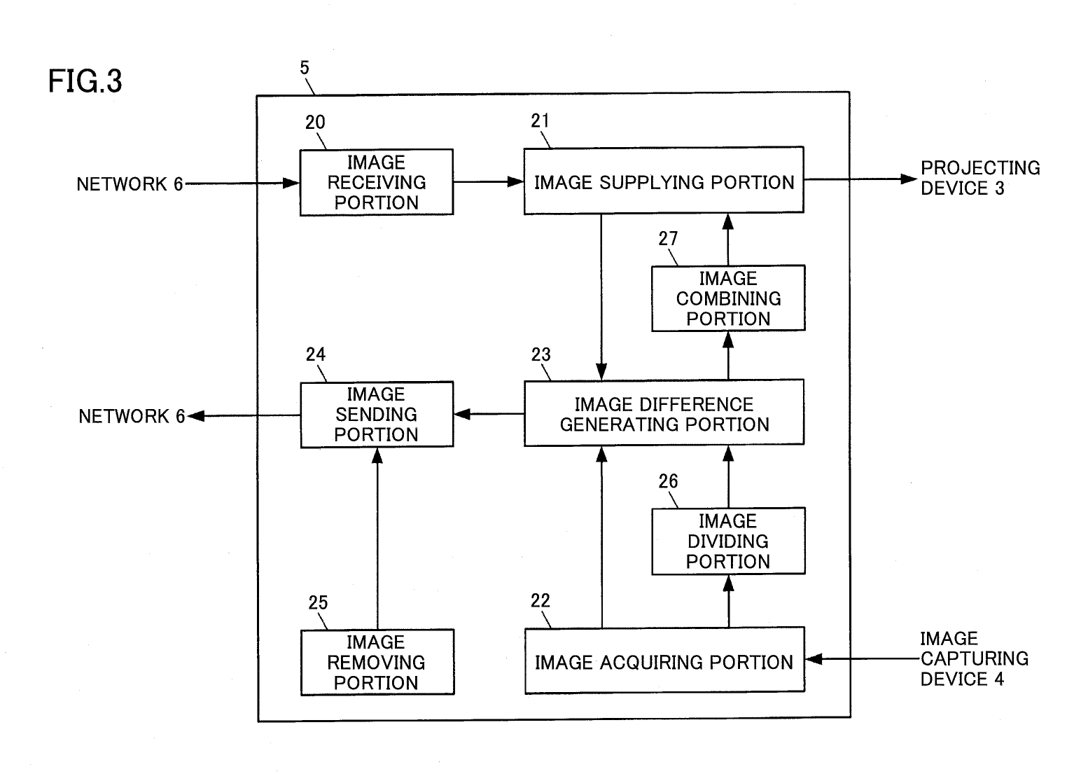

Referring to FIG. 3, the drawn image sharing apparatus 5 includes an image receiving portion 20 configured to receive an image sent from the other drawn image sharing apparatus 5, an image supplying portion 21 configured to supply the image received by the image receiving portion 20, an image acquiring portion 22 configured to acquire the image captured by the image capturing device 4 for the sharing region by which the image is shared by the whiteboards 2, an image difference generating portion 23 configured to generate a difference image between the image projected by the projecting device 3 and the image captured by the image capturing device 4 in the sharing region, an image sending portion 24 configured to send the difference image to the other drawn image sharing apparatus 5, an image removing portion 25 configured to remove an image which should not be displayed on the whiteboard 2 from the image displayed on the whiteboard 2, and an image dividing portion 26 configured to divide the image acquired by the image acquiring portion 22 into a first image and a second image, and an image combining portion 27 configured to combine the difference images generated by the image difference generating portion 23.

The image receiving portion 20 and the image sending portion 24 respectively include the CPUs and the network communicating modules. The image supplying portion 21 and the image acquiring portion 22 include CPUs 10 and the device communicating modules 16. The image difference generating portion 23, the image removing portion 25, the image dividing portion 26 and the image combining portion 27 respectively include the CPUs 10.

The image receiving portion 20 and the image sending portion 24 function in the normal mode. The image supplying portion 21 supplies the image received by the image receiving portion 20 to the projecting device 3 so as to project the received image on the whiteboard 2 in the normal mode. The image supplying portion 21 supplies the image combined by the image combining portion 27 to the projecting device 3 so as to generate the combined image on the whiteboard 2 in the adjusting mode.

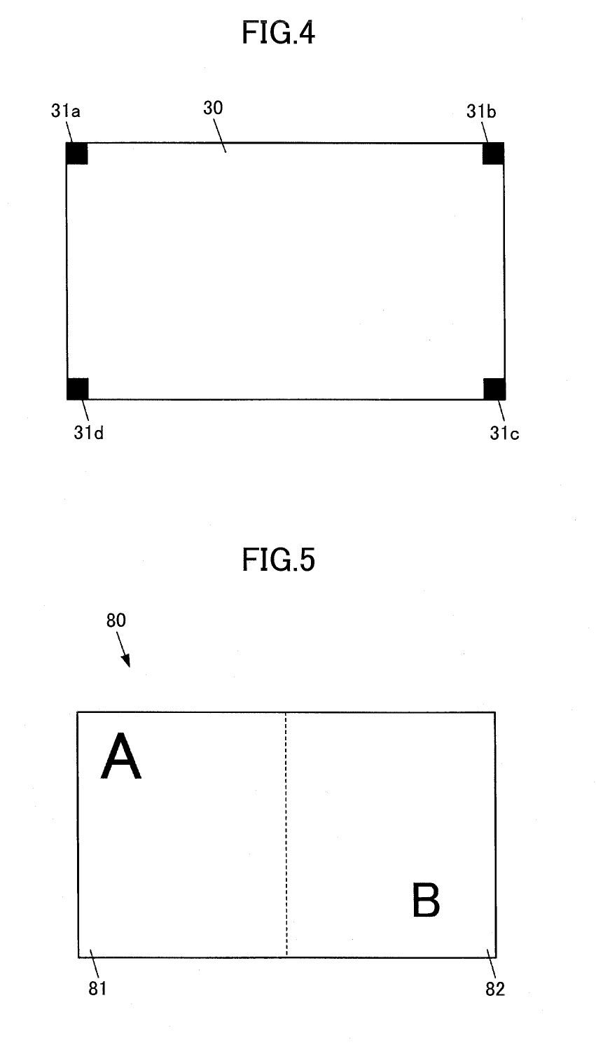

Referring to FIG. 4, the image supplying portion 21 superposes image markers 31a to 31d for specifying the sharing region 30 on the image supplied to the projecting device 3. Referring to FIG. 4, the image markers 31a to 31d are rectangles arranged on four corners of the sharing region 30. It is sufficient that the image markers can specify the sharing region 30. The shapes, numbers and positions of the image markers may be different from those illustrated in FIG. 4.

The image acquiring portion 22 extracts the sharing region 30 after correcting the images with an image correction such as a trapezoidal correction based in the image markers 31a to 31d included the image acquired from the image capturing device 4.

Referring to FIG. 3, the image supplying portion 21 enlarges or reduces the received image so that a region of the image received by the image receiving portion 20 becomes the same as the sharing region 30 of the image supplied to the projecting device 3. The enlarged or reduced image is supplied to the projecting device 3.

The image difference generating portion 23 generates the difference image between the image supplied from the image supplying portion 21 to the projecting device 3 and the image captured by the image capturing device in the sharing region under the normal mode 30.

The image difference generating portion 23 generates, in the adjusting mode, a first difference image between a first image and an image existing in the same region as the first image among the images supplied by the image supplying portion 21 to the projecting device 3 and a second difference image between a second image and an image existing in the same region as the second image among the images supplied by the image supplying portion 21 to the projecting device 3.

The image difference generating portion 23 generates the difference image by comparing the image supplied to the projecting device 3 with the image captured by the image capturing device 4 pixel by pixel.

Specifically, the image difference generating portion 23 generates a difference image formed by pixels at which absolute values of luminance difference between compared pixels is greater than a predetermined threshold or at which distances between the compared pixels on a color space is greater than a predetermined threshold.

The image difference generating portion 23 may generate the difference image by comparing the image supplied to the projecting device 3 with the image captured by the image capturing device 4 in units of a rectangle (e.g., 8 pixels×8 pixels).

In this case, the image difference generating portion 23 generates the difference image formed by the rectangles at which the average values of the absolute values of luminance differences between the compared pixels within the rectangles are greater than a predetermined threshold or at which the average values of the distances between the compared pixels on the color space are greater than a predetermined threshold.

The image difference generating portion 23 may generate the difference image after applying filters respectively to the image supplied to the projecting device 3 and to the image captured by the image capturing device 4.

For example, the image difference generating portion 23 may apply a sharpening filter for extracting a difference between an image of a moving average obtained by averaging pixels of the images with circumjacent pixels and the original image for the images captured by the captured by the image capturing device 4, and apply a smoothing filter to the image supplied to the projecting device 3 and apply a sharpening filter. Then, a difference image between the image captured and applied with the sharpening filter and the image supplied and applied with the smoothing and sharpening filters may be generated.

For example, the image difference generating portion 23 applies a smoothing filter by providing a thickening process to the image supplied to the projecting device 3 using basic operations of Erosion in morphological operations. With this, the image difference generating portion 23 can prevent influence caused by a trapezoidal distortion and a positional shift which have not been corrected.

The image difference generating portion 23 may provide a filtering process to the generated difference image. For example, the image difference generating portion 23 may have a filter for removing a color element of at least one of lime green and yellow. With this, the image difference generating portion 23 can remove a bright line 23 of lime green or yellow contained in a light source of a projector constituting the projecting device 3 from the difference image.

The image sending portion 24 may send the difference image generated by the image difference generating portion 23 to the other drawn image sharing apparatus 5. When the difference image generated by the image difference generating portion 23 is blank (no difference between the images or the same as the previously sent difference image), the image sending portion 24 may not send the difference image.

In this case, the image sending portion 24 may be constituted to store the difference image in a recording medium such as the RAM 11 before sending the difference image to the other drawn image sharing apparatus 5 and to compare the difference image with the difference image to be sent.

When the difference image is generated by the image difference, an artifact may be projected on the whiteboard 2 even though nothing is drawn on the whiteboard 2. The artifact is an unwanted image displayed on the whiteboard as if it is drawn on the whiteboard 2. The artifact may be caused depending on a drawing timing, a transmission delay in the network and so on.

The image removing portion 25 ordinarily functions under the normal mode and carries out an image resetting process of removing the unwanted image which should not be displayed on the whiteboard 2 from the image displayed on the whiteboard 2.

Specifically, the image removing portion 25 makes an image sending portion 24 send an image marked out with white color being a background color of the whiteboard 2 to carry out the image resetting process.

With the image resetting process, only the image which should be displayed on the whiteboard 2 is sent from the other drawn image sharing apparatus 5 as the difference image. Therefore, an image from which the unwanted image is removed is projected on the whiteboard 2. The difference image is generated by the image difference generating portion 23 based on the captured image of the sharing region of the whiteboard and sent to the other drawn image sharing apparatus 5. Therefore, the image from which the unwanted image is removed is projected on the other drawn image sharing apparatus 5.

Meanwhile, the image removing portion 25 may carry out the image resetting process with a predetermined time interval (e.g., 10 seconds) upon a request via the input device 14.

The image removing portion 25 may analyze the image acquired by the image acquiring portion 22 to enable carrying out the image resetting process after an image of an obstacle or the like goes out of the image of the sharing region.

The image removing portion 25 may analyze the image acquired by the image acquiring portion 22 to enable carrying out the image resetting process after an image of an obstacle such as a person who draws on the whiteboard 2 goes out of the image of the sharing region.

The image removing portion 25 may analyze the image supplied from the image supplying portion 21 to the projecting device 3 to enable carrying out the image resetting process after the image of the obstacle such as the person who draws on the whiteboard 2 goes out of the image of the sharing region.

The image dividing portion 26 functions in the adjusting mode and divides the image 80 acquired by the image acquiring portion 22 into a first image 81 and a second image 82. FIG. 5 illustrates an example in which the image acquired by the image acquiring portion 22 is bisected left and right by the image dividing portion 26. The image dividing portion 26 may bisect the image up and down or diagonally.

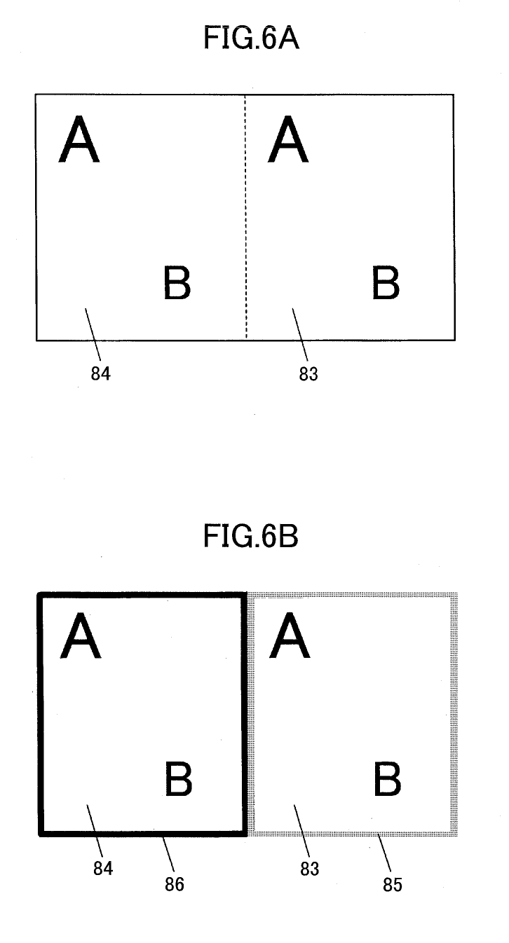

The image combining portion 27 functions under the adjusting mode. For example, referring to FIG. 6A, the first difference image 83 is allocated to the position of the second image, and the second difference image 84 is allocated to the position of the first image to thereby combine the first difference image and the second difference image.

The image combining portion 27 outputs the combined image to the image supplying portion 21. When the combined image generated by the image combining portion 27 is blank or the same as the combined image previously sent, the image combining portion 27 may not output the combined image to the image supplying portion 21.

For example, as illustrated in FIG. 6B, the image combining portion 27 may superpose images 85 and 86 indicative of a boundary of the first difference image 83 and a boundary of the second difference image 84 on the first difference image and the second difference image, respectively.

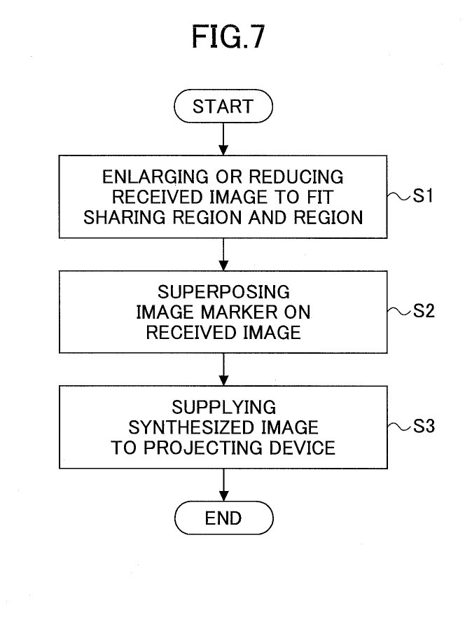

Referring to FIGS. 7 to 14, the operation of the drawn image sharing apparatus 5 described above is explained.

FIG. 7 is a flowchart for illustrating the shared image receiving operation in the normal mode of the drawn image sharing apparatus 5. The shared image receiving operation described below starts when the image sent from the other drawn image sharing apparatus 5 is received by the image receiving portion 20.

The image received by the image receiving portion 20 is enlarged or reduced by the image supplying portion 21 so that a region of the received image conforms to the sharing region of the image supplied to the projecting device 3 in step S1.

Next, the image marker is superposed on the received image by the image supplying portion 21 in step S2 and supplied to the projecting device 3 in step S3. As described, the image supplied to the projecting device 3 is projected on the whiteboard 2.

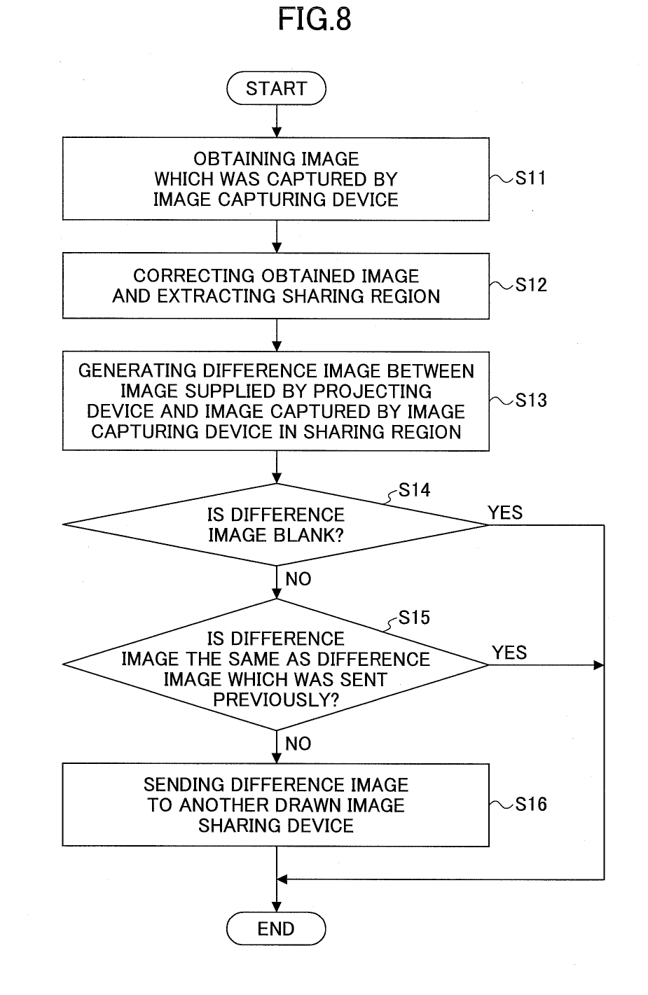

FIG. 8 is a flowchart for illustrating the captured image receiving operation in the normal mode of the drawn image sharing apparatus 5. The captured image receiving operation starts when the image is captured by the image capturing device 4.

The image captured by the image capturing device 4 is acquired by the image acquiring portion 22 in step S11. The image acquired by the image acquiring portion 22 is provided with an image correction based on the positions of the image marker contained in the image. Thereafter, the sharing region is extracted in step S12.

Next, the difference image indicative of a difference in the sharing region between the image supplied from the image supplying portion 21 to the projecting device 3 and the image captured by the image capturing device is generated by the image difference generating portion 23 in step S13.

Then, it is determined whether the difference image generated by the image difference generating portion 23 is blank by the image sending portion 24 in step S14. If it is determined that the difference image is blank, the captured image receiving operation ends.

On the other hand, if it is determined that the difference image is not blank, it is determined by the image sending portion 24 whether the difference image generated by the image difference generating portion 23 is the same as the previously sent difference image in step S15.

If it is determined by the image sending portion 24 that the difference image generated by the image difference generating portion 23 is the same as the previously sent difference image, the captured image receiving operation ends. On the other hand, if it is determined by the image sending portion 24 that the difference image generated by the image difference generating portion 23 is not the same as the previously sent difference image, the difference image is sent by the image sending portion 24 to the other drawn image sharing apparatus 5 in step S16.

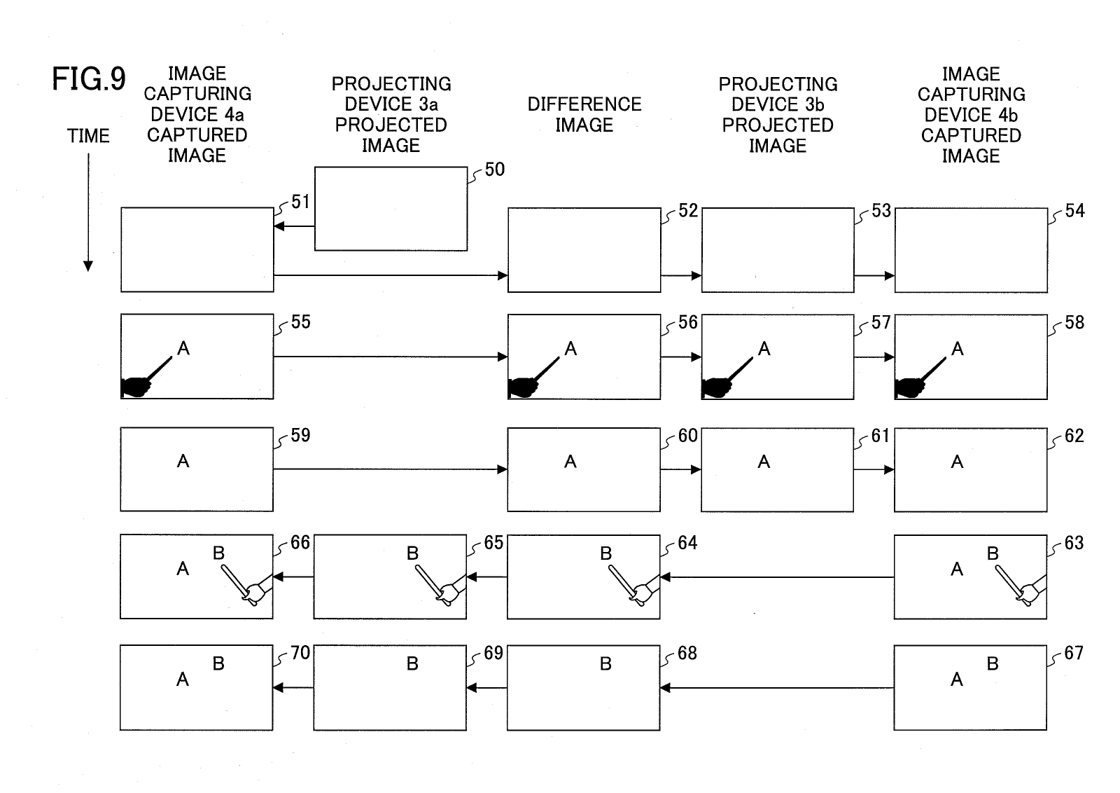

FIG. 9 schematically illustrates an exemplary operation in the normal mode of the drawn image sharing system 1 of the embodiment. Referring to FIG. 9, the difference image substituted between locational points where the drawn image sharing apparatuses 5a, 5b are located, difference images, projected images projected by the projecting devices 3a, 3b, and captured images captured by the image capturing devices 4a, 4b are exemplified in chronological order.

When a session is established between the drawn image sharing apparatus 5a and the drawn image sharing apparatus 5b, one of the captured images captured by the drawn image sharing apparatus 5a and the drawn image sharing apparatus 5b is sent to the other drawn image sharing apparatus 5 as the difference image.

At first, the blank projected image 50 is projected on the whiteboard 2a by the projecting device 3a, and the image capturing device 4a captures the projected image 50 as the captured image 51, and the drawn image sharing apparatus 5a sends the captured image 51 as the difference image 52 to the drawn image sharing apparatus 5b.

Then, the projecting device 3b projects the blank projected image 53 on the whiteboard 2b, and the image capturing device 4b captures the projected image as the captured image 54. Because the difference image between the projected image 53 and the captured image 54 is blank, the drawn image sharing apparatus 5b does not send the difference image.

Next, something such as a letter “A” is drawn by an obstacle such as a human hand on the sharing region of the whiteboard 2a, and the image capturing device 4a captures the drawn image as a captured image 55. Then, the drawn image sharing apparatus 5a sends a difference image 56 between the projected image 50 and the captured image to the drawn image sharing apparatus 5b.

Then, the projecting device 3b projects the difference image 56 as a projected image 57 on the whiteboard 2b, and the image capturing device 4b captures the projected image 57 as a captured image 58. Because a difference image between the projected image 57 and the captured image 58 is blank, the drawn image sharing apparatus 5b does not send the difference image.

Next, the obstacle such as the human hand disappears from the sharing region of the whiteboard 2a, and the image capturing device 4a captures the whiteboard as a captured image 59. Then, a difference image 60 between the projected image 50 and the captured image 59 is sent from the drawn image sharing apparatus 5a to the drawn image sharing apparatus 5b.

Then, the projecting device 3b projects the difference image 60 on the whiteboard 2b as a projected image 61, and the image capturing device 4b captures the projected image 61 as a captured image 62. Because a difference image between the projected image 61 and the captured image 62 is blank, the drawn image sharing apparatus 5b does not send the difference image.

Next, something such as a letter “B” is drawn by an obstacle such as a human hand on the sharing region of the whiteboard 2a, and the image capturing device 4b captures the drawn image as a captured image 63. Then, the drawn image sharing apparatus 5b sends a difference image 64 between the projected image 61 and the captured image 64 to the drawn image sharing apparatus 5a.

Then, the projecting device 3a projects the difference image 64 on the whiteboard 2b as a projected image 65, and the image capturing device 4a captures the projected image 65 as a captured image 66. Because a difference image between the projected image 65 and the captured image 66 and the previously send difference image 60 are the same, the drawn image sharing apparatus 5a does not send the difference image.

Next, the obstacle such as the human hand disappears from the sharing region of the whiteboard 2b, and the image capturing device 4b captures the whiteboard as a captured image 67. Then, a difference image 68 between the projected image 61 and the captured image 67 is sent from the drawn image sharing apparatus 5b to the drawn image sharing apparatus 5a.

Then, the projecting device 3a projects the difference image 68 on the whiteboard 2b as a projected image 69, and the image capturing device 4a captures the projected image 69 as a captured image 70. Because a difference image between the projected image 69 and the captured image 70 and the previously send difference image 60 are the same, the drawn image sharing apparatus 5a does not send the difference image.

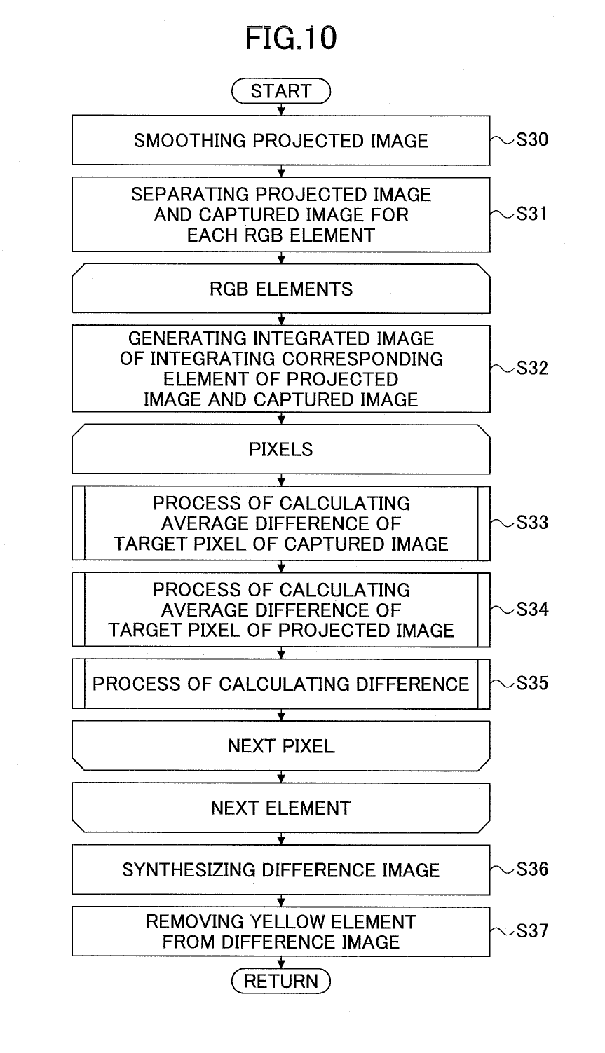

In the captured image receiving operation with the drawn image sharing apparatus 5 illustrated in FIG. 8, a case where the image difference generating portion 23 applies a filter to the captured image, the projected image, and a difference image generated based on the captured image and the projected image is exemplified. Referring to FIG. 10 to FIG. 12, the difference image generating process in step S13 is described in detail.

The smoothing filter providing a projected image with a thickening process is applied by the difference generating portion 23 in step S30. Then, the smoothed projected image and the captured image are divided by the image difference generating portion 23 into a red (R) element, a green (G) element and a blue (B) element in step S31.

Next, the following steps S32 to S35 are provided to the red (R) element, the green (G) element and the blue (B) element. The R element, the G element and the B element have values in a range of 0 to 255. The greater the value becomes, the greater the luminance becomes. Said differently, when the red (R) element, the green (G) element and the blue (B) element have the value of 0, the color of the pixel becomes black. When the red (R) element, the green (G) element and the blue (B) element have the value of 255, the color of the pixel becomes white.

Integrated images of the red (R) element, the green (G) element and the blue (B) element formed by integrating the red (R) elements, the green (G) elements and the blue (B) elements of the projected image and the captured image are generated in step S32.

Steps S33 to S35 described below are carried out for pixels of the captured image and pixels of the projected image.

An average difference calculating process is carried out by the image difference generating portion 23 in step S33. The average difference calculating process is to calculate an average difference which is obtained by averaging the values of elements of a target pixel using the values of elements of circumjacent pixels positioned around the target pixel.

In the average difference calculating process, a rectangle having a size of m×n (m and n are predetermined constants around the target pixel is calculated by the image difference generating portion 23 in step S40. In a case where the size of the captured image is 1024 pixels×768 pixels, for example, m=n=31 pixels.)

Next, the integrated image calculated in step S32 (see FIG. 10) is used to calculate an average value of luminance inside the rectangle calculated in step S40 with the image difference generating portion 23 in step S41.

Specifically, provided that the luminance at the top left of the rectangle of the integrated image is designated as LT, the luminance at the top right of the rectangle of the integrated image is designated as RT, the luminance at the bottom left of the rectangle of the integrated image is designated as LB, the luminance at the bottom right of the rectangle of the integrated image is designated as RB, and the number of pixels inside the rectangle is PN, an average value AVG is calculated by the following formula.

AVG=(RB−RT−LB+LT)/PN

The calculated average value AVG is subtracted from the luminance of the target pixel with the image difference generating portion 23 to thereby calculate the average difference of the target pixel in step S42. Thus, the average difference calculating process ends.

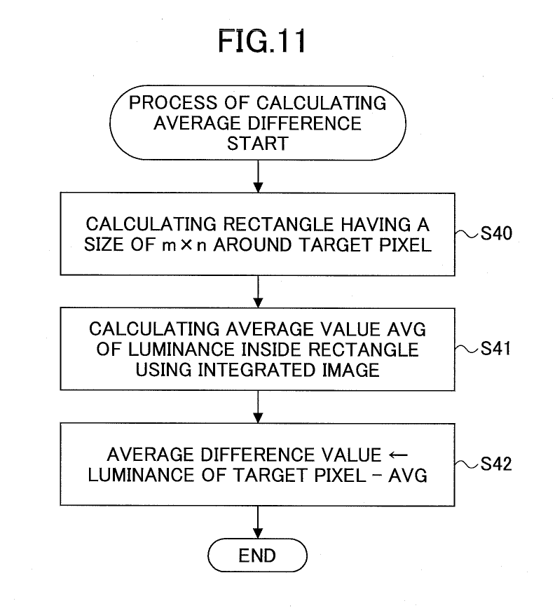

Referring to FIG. 10, when the average difference calculating process for the target pixel of the captured image ends, the average difference calculating process described with reference to FIG. 11 is carried out by the image difference generating portion 23 in step S34.

Next, based on the average difference of the target pixel of the captured image and the average difference of the target pixel of the projected image, a difference calculating process for calculating a difference value between the average differences of the target pixels of the captured image and the projected image is carried out by the image difference generating portion 23 in step S35.

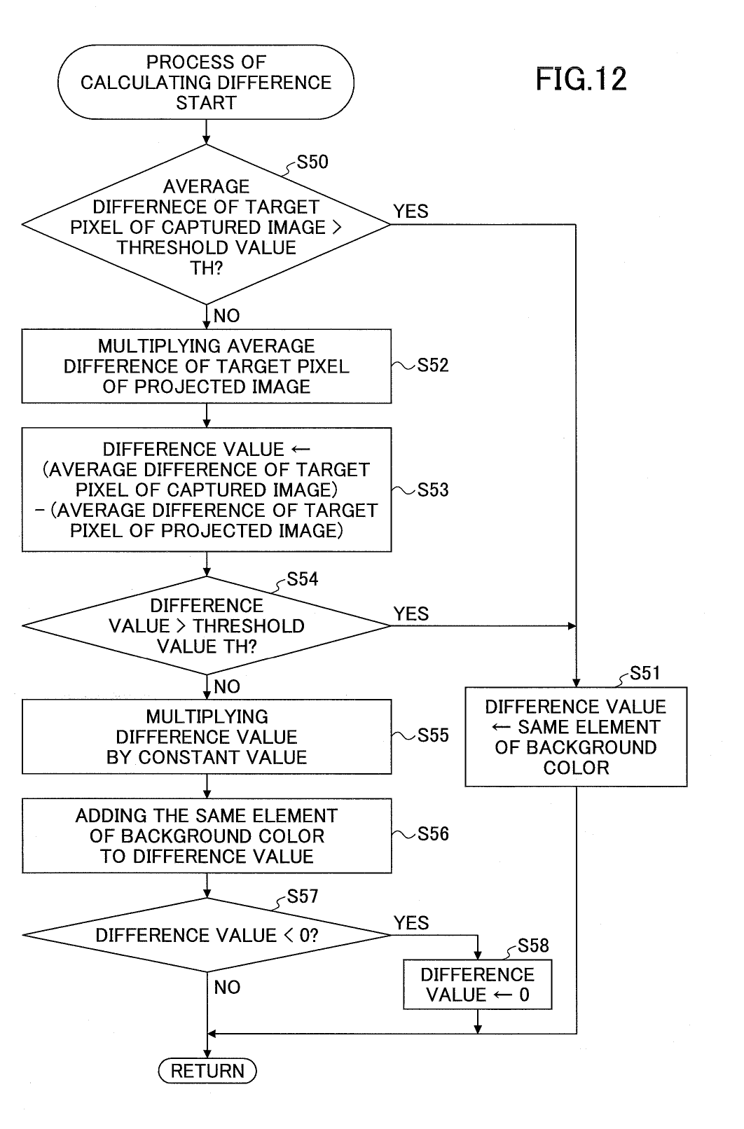

Referring to FIG. 12, in the difference calculating process, it is determined by the image difference generating portion 23 whether the average difference (luminance) between the target pixels of the captured image and the projected image is greater than a predetermined threshold TH in step S50. The threshold value TH may be −5 in this example.

When the average difference is determined to be greater than the threshold value TH, the difference value is set to elements of a background color in step S51. Then, the difference calculating process ends. Meanwhile, if it is determined that the average difference of the target pixel of the projected image is not greater than the threshold value TH, the average difference of the target pixel of the projected image is multiplied by a constant (e.g., 1.5 times) with the image difference generating portion 23 to increase the average difference (e.g., to thicken the image) in step S52.

Subsequently, the image difference generating portion 23 subtracts the average difference of the target pixel of the projected image which has been multiplied by the constant from the average difference of the target pixel of the captured image in step S53. Next, it is determined whether the difference value obtained as the subtraction is greater than the threshold value TH by the image difference generating portion 23 in step S54.

When the difference value is determined to be greater than the threshold value TH, the target pixel of the captured image can be determined to be noise such as externally entering light which is brighter than the background. Then, the image difference generating portion 23 sets the difference value to the element having the same color as the background color in step S51. Then, the difference calculating process ends.

Meanwhile, if it is determined that the difference value is not greater than the threshold value TH, the difference value is multiplied by a constant (e.g., 1.5 times) with the image difference generating portion 23 to increase the difference value (e.g., to thicken the image) in step S55. The element having the same color as the background color is added to the difference value by the image difference generating portion 23 in step S56. In the embodiment, the elements of the background color are designated as reference symbol 200.

It is determined by the image difference generating portion 23 whether the difference value is less than 0 (zero). If it is determined by the image difference generating portion 23 that the difference value is less than 0 (zero), the difference value is set to be 0 (zero) in step S58, and the difference calculating process ends. On the other hand, if it is determined by the image difference generating portion 23 that the difference value is not less than (zero), the difference calculating process ends.

When the above described processes for the RGB elements of the pixels of the captured image and the projected image end, the difference images formed by the pixels having the difference values of the RGB elements are synthesized by the image difference generating portion 23 in step S36.

Finally, a filter for removing a yellow element is applied to the difference image by the image difference generating portion 23 in step S37. For example, provided that the luminance values of the RGB elements of the pixels of the difference image are designated as Ir, Ig and Ib respectively, the yellow element can be removed from the pixel by establishing Ib=min (Ir, Ig) where min (Ir, Ig)>Ib.

In this example, although the image difference generating portion 23 applies the filter for removing the yellow element from the difference image in step S37, a filter for removing a yellowish green element may be applied to the difference image or a filter of removing yellow and yellowish green elements may be applied to the difference image.

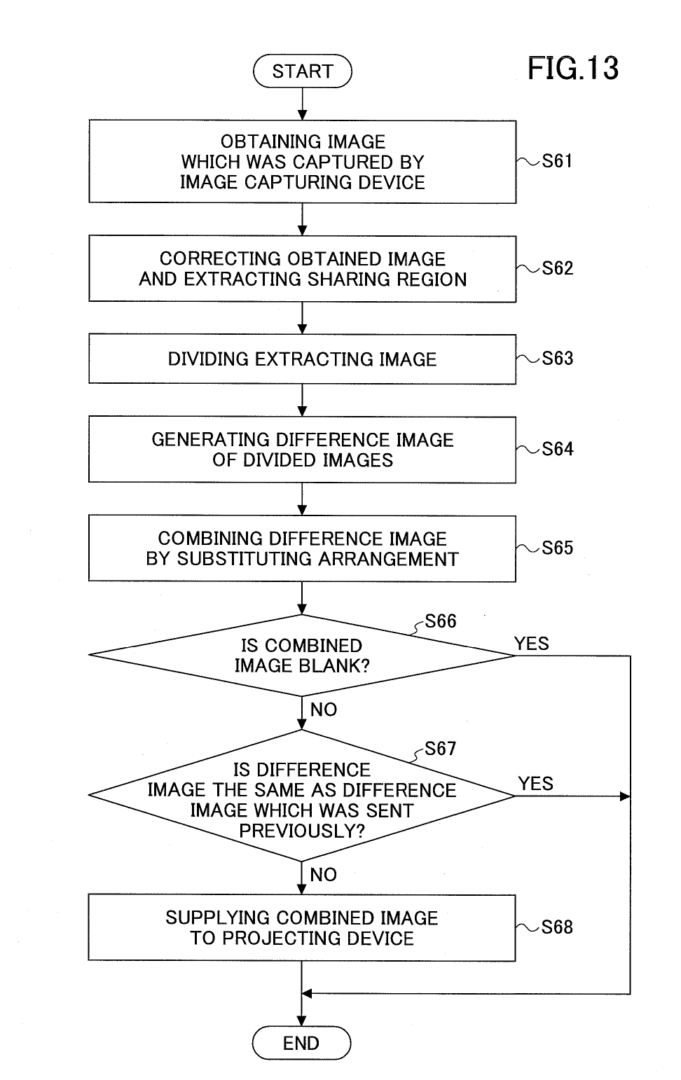

FIG. 13 is a flowchart for illustrating the captured image receiving operation in the adjusting mode of the drawn image sharing apparatus 5. The captured image receiving operation described below starts when the image is captured by the image capturing device 4.

An image captured by the image capturing device 4 is acquired by the image acquiring portion 22 in step S61. An image acquired by the image acquiring portion 22 is provided with an image correction based on the positions of an image marker contained in the image. Thereafter, a sharing region is extracted from the corrected image in step S62.

Next, the extracted image of the sharing region is divided by the image dividing portion 26 into a first image and a second image in step S63. The image difference generating portion 23 generates difference images of the first image and the second image, which are divided by the image dividing portion 26 in step S64.

Said differently, the image difference generating portion 23 generates a first difference image indicative of a difference between the first image and an image of the same region as the first image contained in the images supplied to the projecting device 3, and a second difference image indicative of a difference between the second image and an image of the same region as the second image contained in the images supplied to the projecting device 3.

The first difference image and the second difference image generated by the image difference generating portion 23 are combined after exchanging the arrangement of the first difference image and second difference image in step S65. Said differently, the image combining portion 27 arranges the first difference image at the position of the second image, and arranges the second difference image at the position of the first image. Then, the first difference image is combined with the second difference image.

The image combining portion 27 determines whether the combined image of the first difference image and the second difference image is blank in step S66. If it is determined that the first and second difference images are blank, the captured image receiving operation ends.

On the other hand, if it is determined that at least one of the first and the second difference images is not blank, the image combining portion 27 determines whether the combined image combined by the image combining portion 27 is the same as the previously combined image in step S67.

If it is determined by the image combining portion 27 that the combined image combined by the image combining portion 27 is the same as the previously combined image, the captured image receiving operation ends. On the other hand, if it is determined that the combined image combined by the image combining portion 27 is not the same as the previously combined image, the combined image is supplied to the projecting device 3 by the image supplying portion 21 in step S68. As described, the combined image supplied to the projecting device 3 is projected on the whiteboard by the projecting device 3.

In the captured image receiving operation of the drawn image sharing apparatus in the adjusting mode, in a similar manner to the captured image receiving operation in the normal mode, the image difference generating portion 23 may apply a filter to the captured image, the projected image and the difference image generated based on the captured image and the projected image.

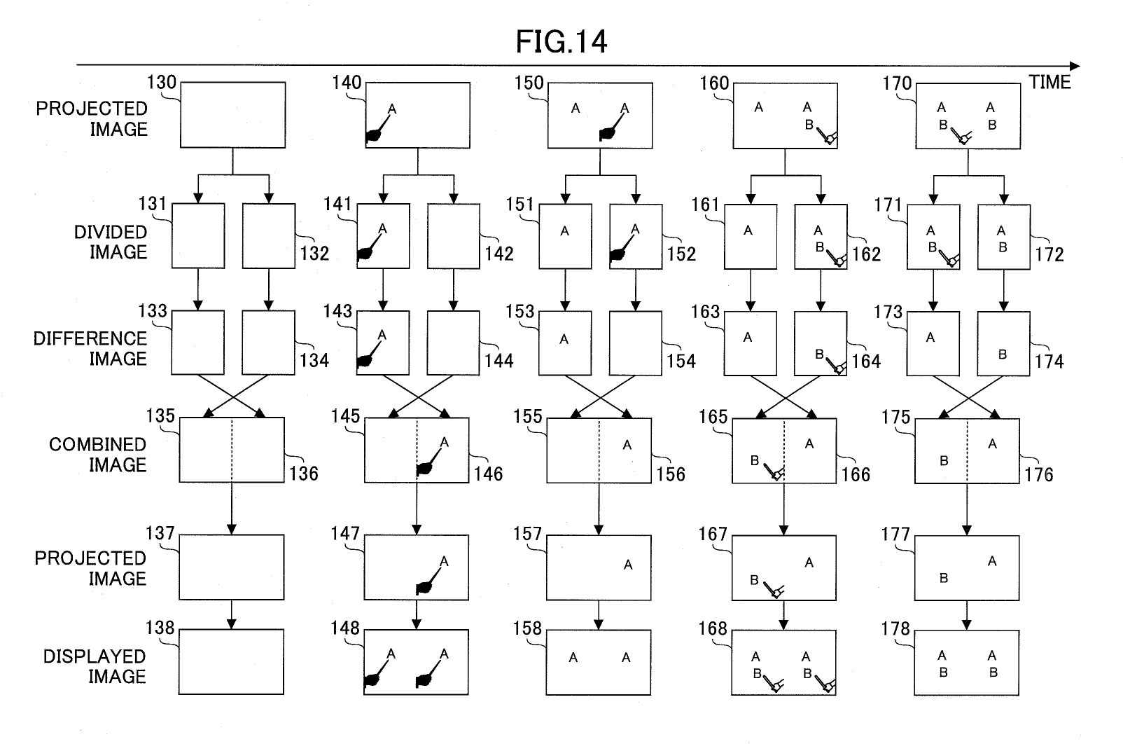

FIG. 14 schematically illustrates an exemplary operation in the adjusting mode of the drawn image sharing system 1 of the embodiment. Referring to FIG. 14, the captured image, the first and the second divided images (hereinafter, collectively referred to as “divided image”), the first and the second difference images (hereinafter, collectively referred to as “difference image”), the combined image, the projected image, and the image displayed on the whiteboard 2 (hereinafter, referred to as “displayed image”) are arranged in chronological order.

The projecting device 3 projects a blank projected image to the whiteboard 2 with the projecting device 3. The blank projected image is captured by the image capturing device as the captured image 130. The captured image is divided by the image dividing portion 26 into a divided image 131 and a divided image 132.

The divided images 131 and 132 are changed to the difference images 133 and 134. Then, the image combining portion 27 substitutes the positions of the difference images 133 and 134 left and right and combines the substituted images as combined images 135 and 136. The combined images 135 and 136 are supplied by the image supplying portion 21 to the projecting device 3 as a projected image 137. With this, the projected image 137 is projected on the whiteboard 2 by the projecting device 3 and a displayed image 138 is displayed on the whiteboard 2.

Next, something such as a letter “A” is drawn by an obstacle such as a human hand on a left side of the sharing region of the whiteboard 2. The image capturing device 4 captures it as a captured image 140. The captured image 140 is divided by an image dividing portion 26 into a divided image 141 and a divided image 142. Here, the image difference generating portion 23 generates a difference image between the combined image 135 and the divided image 1 and a difference image 144 between the combined image 136 and the divided image 142.

The image combining portion 27 substitutes the positions of the difference images 143 and 144 and combines the substituted images as combined images 145 and 146. The combined images 145 and 146 are supplied by the image supplying portion 21 to the projecting device 3 as a projected image 147. With this, the projected image 147 is projected on the whiteboard 2 by the projecting device 3 and a displayed image 148 is displayed on the whiteboard 2.

Next, the obstacle such as the human hand disappears from the left side of the sharing region of the whiteboard 2 and the whiteboard is captured by the image capturing device 4 as a captured image 150. The captured image 150 is divided by an image dividing portion 26 into a divided image 151 and a divided image 152. Here, the image difference generating portion 23 generates a difference image 153 between the combined image 145 and the divided image 151 and a difference image 154 between the combined image 146 and the divided image 152.

The image combining portion 27 substitutes the positions of the difference images 153 and 154 and combines the substituted images as combined images 155 and 156. The combined images 155 and 156 are supplied by the image supplying portion 21 to the projecting device 3 as a projected image 157. With this, the projected image 157 is projected on the whiteboard 2 by the projecting device 3 and a displayed image 158 is displayed on the whiteboard 2.

Next, something such as a letter “B” is drawn by an obstacle such as a human hand on a right side of the sharing region of the whiteboard 2. The image capturing device 4 captures it as a captured image 160. The captured image 160 is divided by the image dividing portion 26 into a divided image 161 and a divided image 162. Here, the image difference generating portion 23 generates a difference image 163 between the combined image 155 and the divided image 161 and a difference image 164 between the combined image 156 and the divided image 162.

The image combining portion 27 substitutes the positions of the difference images 163 and 164 and combines the substituted images as combined images 165 and 166. The combined images 165 and 166 are supplied by the image supplying portion 21 to the projecting device 3 as a projected image 167. With this, the projected image 167 is projected on the whiteboard 2 by the projecting device 3 and a displayed image 168 is displayed on the whiteboard 2.

Next, the obstacle such as the human hand disappears from the right side of the sharing region of the whiteboard 2 and the whiteboard is captured by the image capturing device 4 as a captured image 170. The captured image 170 is divided by the image dividing portion 26 into a divided image 171 and a divided image 172. Here, the image difference generating portion 23 generates a difference image 173 between the combined image 165 and the divided image 171 and a difference image 174 between the combined image 166 and the divided image 172.

The image combining portion 27 substitutes the positions of the difference images 173 and 174 and combines the substituted images as combined images 175 and 176. The combined images 175 and 176 are supplied by the image supplying portion 21 to the projecting device 3 as a projected image 177. With this, the projected image 177 is projected on the whiteboard 2 by the projecting device 3 and a displayed image 178 is displayed on the whiteboard 2.

As described, the drawn image sharing system 1 of the embodiment can confirm the difference image to be sent to the other drawn image sharing apparatus 5 on the drawn image sharing apparatus by referring to the image projected from the projecting device 3. Therefore, it is possible to optimally set the image capturing device 4 easier than ever.

Because the drawn image sharing system 1 may be constituted by an ordinary projector, the image capturing device 4 may be constituted by an ordinary video camera, and the drawn image sharing apparatus 5 may be constituted by an ordinary computer. Therefore, a cost for the hardware can be reduced.

In the embodiment, the example that the images drawn on the two drawn image sharing apparatuses 5 are shared by the whiteboards 2 has been described. However, the number of the drawn image sharing apparatuses 5 may be three or more and the images drawn on corresponding whiteboards 2 as many as three or more may be shared by the whiteboards 2.

In this case, the image supplying portion 21 enlarges or reduces an image received from any of the drawn image sharing apparatuses 5. Thereafter, the image supplying portion 21 stores the enlarged or reduced image in a recording medium such as a RAM 11 in correspondence with the drawn image sharing apparatus 5 on the sending side. The received images which correspond to the drawn image sharing apparatuses and which are stored in the recording medium are synthesized. The synthesized image is supplied to the projecting device 3.

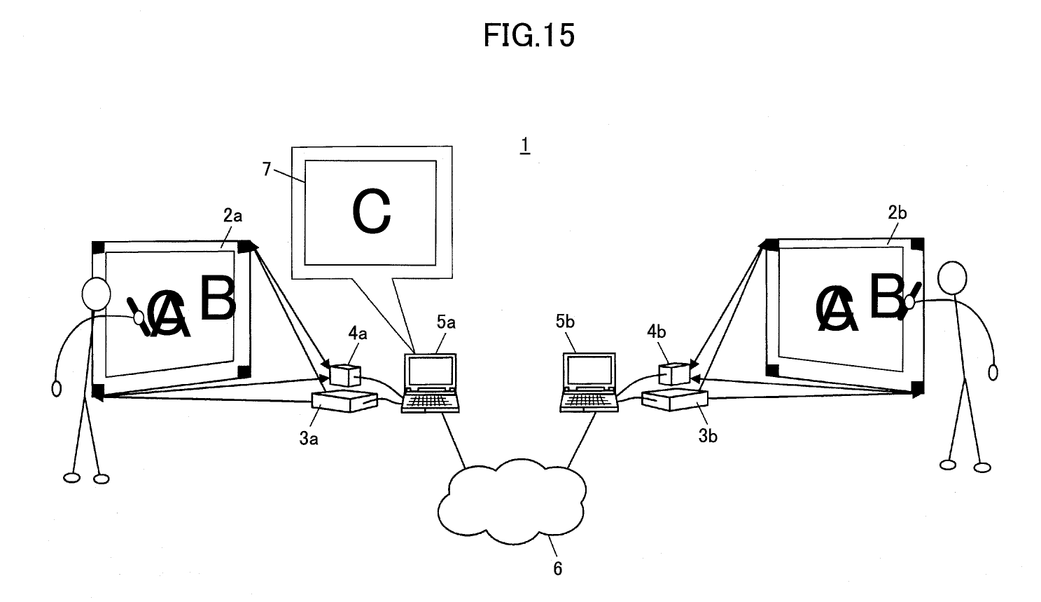

Referring to FIG. 15, image data displaying an image 7 may be stored by a recording medium such as the hard disk device 13. The image supplying portion 21 may superpose the image supplied to the projecting device 3 on the image 7 and supply the superposed image to the projecting device 3.

With this, not only the image drawn on the whiteboard 2, but also an image displayed by electronic data, may be shared by the whiteboards 2.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made thereto without departing from the spirit and scope of the invention.

This patent application is based on Japanese Priority Patent Application No. 2010-248729 filed on Nov. 5, 2010, the entire contents of which are hereby incorporated herein by reference.

What is claimed is:

1. A drawn image sharing apparatus making a plurality of objects to be drawn on share images drawn on the objects to be drawn on with focusing devices and image capturing devices, the drawn image sharing apparatus comprising:
an image receiving portion configured to receive an image sent from another drawn image sharing apparatus;
an image supplying portion configured to supply the received image to the focusing device to produce an image on the object to be drawn on;
an image acquiring portion configured to acquire a sharing region image of a sharing region, on which the images are shared, from the image capturing device which captures the sharing image;
an image difference generating portion configured to generate a difference image being a difference between an image produced by the focusing device and the image captured by the image capturing device in the sharing region;
an image sending portion configured to send the difference image to the other drawn image sharing apparatus;
an image dividing portion configured to divide the image acquired by the image acquiring portion into a first image and a second image; and
an image combining portion configured to combine the difference image generated by the image difference generating portion,
wherein in an adjusting mode of adjusting the image capturing device,
the image difference generating portion generates a first difference image being a difference between one of the images supplied by the image supplying portion corresponding to the same region as a region of the first image and the first image and a second difference image being a difference between one of the images supplied by the image supplying portion corresponding to the same region as a region of the second image and the second image,
the image combining portion arranges the first difference image at a position of the second image and arranges the second difference image at a position of the first image and thereafter combines the first difference image and the second difference image, and
the image supplying portion supplies the combined image to the focusing device to produce the image.

2. The drawn image sharing apparatus according to claim 1,
wherein the image combining portion superposes an image of a boundary of the first difference image on the first difference image and superposes an image of a boundary of the second difference image on the second difference image.

3. The drawn image sharing apparatus according to claim 1,
wherein the image supplying portion superposes an image marker for specifying the sharing region on an image to be supplied to the focusing device, and
the image acquiring portion extracts the sharing region based on a position of the image marker contained in the image acquired from the image capturing device.

4. The drawn image sharing apparatus according to claim 1,
wherein the image difference generating portion applies a thickening process to an image produced by the focusing device, and the difference image is generated based on the image provided with the thickening process and the image captured by the image capturing device.

5. The drawn image sharing apparatus according to claim 1,
wherein the image difference generating portion includes a filter for removing at least one of color elements of lime green and yellow from the generated difference image.

6. A drawn image sharing system comprising:
a plurality of objects to be drawn on sharing images drawn on the objects to be drawn on with focusing devices and image capturing devices; and
a plurality of drawn image sharing apparatuses respectively corresponding to the objects to be drawn on sharing images, each of the drawn image sharing apparatuses including
an image receiving portion configured to receive images sent from another of the drawn image sharing apparatuses;
an image supplying portion configured to supply the received image to the focusing device to produce an image on the object to be drawn on;
an image acquiring portion configured to acquire a sharing region image of a sharing region, on which the images are shared, from the image capturing device which captures the sharing image;
an image difference generating portion configured to generate a difference image being a difference between an image produced by the focusing device and the image captured by the image capturing device in the sharing region;
an image sending portion configured to send the difference image to the other of the drawn image sharing apparatuses;
an image dividing portion configured to divide the image acquired by the image acquiring portion into a first image and a second image; and
an image combining portion configured to combine the difference image generated by the image difference generating portion,
wherein in an adjusting mode of adjusting the image capturing device,
the image difference generating portion generates a first difference image being a difference between one of the images supplied by the image supplying portion corresponding to the same region as a region of the first image and the first image and a second difference image being a difference between one of the images supplied by the image supplying portion corresponding to the same region as a region of the second image and the second image,
the image combining portion arranges the first difference image at a position of the second image and arranges the second difference image at a position of the first image and thereafter combines the first difference image and the second difference image, and
the image supplying portion supplies the combined image to the focusing device to produce the image.

7. A drawn image sharing method causing a plurality of objects to be drawn on to display images drawn on the objects to be drawn on with focusing devices and image capturing devices of a plurality of drawn image sharing apparatuses, the drawn image sharing apparatuses respectively corresponding to the objects to be drawn on, the drawn image sharing method comprising:
receiving, with a second drawn image sharing apparatus of the drawn image sharing apparatuses, images sent from a first drawn image sharing apparatus of the drawn image sharing apparatuses;
supplying, with the second drawn image sharing apparatus, the received image to the focusing device of the second drawn image sharing apparatus of the drawn image sharing apparatuses to produce an image on a second object to be drawn on of the objects to be drawn on;
acquiring, with the second drawn image sharing apparatus, a sharing region image of a sharing region, on which the images are shared by a first object to be drawn on of the objects to be drawn on and the second object to be drawn on, from a second image capturing device of the image capturing devices which captures the sharing image;
generating, with the second drawn image sharing apparatus, a difference image being a difference between an image produced by the second focusing device and the image captured by the second image capturing device in the sharing region;
sending, with the second drawn image sharing apparatus, the difference image to the first drawn image sharing apparatus;
dividing, with the second drawn image sharing apparatus, the acquired sharing region image into a first image and a second image; and
combining, with the second drawn image sharing apparatus, the generated difference image,
wherein in an adjusting mode of adjusting the second image capturing device of the second drawn image sharing apparatus,
the generating, with the second drawn image sharing apparatus, the difference image includes generating a first difference image being a difference between one of the images supplied by the supplying and corresponds to the same region as a region of the first image and the first image and a second difference image being a difference between one of the images supplied by the supplying portion and corresponds to the same region as a region of the second image and the second image,
the combining, with the second drawn image sharing apparatus, the generated difference image includes arranging the first difference image at a position of the second image and arranging the second difference image at a position of the first image and thereafter combining the first difference image and the second difference image, and
the supplying, with the second drawn image sharing apparatus, the received image to the focusing device of the second image sharing apparatus includes supplying the combined image to the second focusing device to produce the image.
